(19) United States
(12) Patent Application Publication
(10) Pub. No.: US 2020/0059768 A1
(43) Pub. Date: Feb. 20, 2020

(54) VEHICLE TERMINAL AND OPERATION METHOD THEREOF

(71) Applicant: LG Electronics Inc., Seoul (KR)

(72) Inventor: Ganghee YU, Seoul (KR)

(21) Appl. No.: 16/661,491

(22) Filed: Oct. 23, 2019

(30) Foreign Application Priority Data
Oct. 4, 2019 (KR) 10-2019-0123022

(51) Int. Cl. H04W 4/46; G05D 1/02

(52) U.S. Cl. CPC H04W 4/46; G05D 1/021

(57) ABSTRACT

Provided are a method of verifying whether to allow vehicle to vehicle (V2V) communication with an external vehicle by comparing first information of an external vehicle and second information of at least one vehicle, and a vehicle terminal therefor. In the present disclosure, at least one of a vehicle, a vehicle terminal, and an autonomous vehicle may be associated with an artificial intelligence (AI) module, an unmanned aerial vehicle (UAV), a robot, an augmented reality (AR) device, a virtual reality (VR) device, a device related to a 5G service, and the like.

### CROSS-REFERENCE TO RELATED APPLICATION

This application claims the benefit of priority to Korean Application No. 10-2019-0123022, filed on Oct. 4, 2019, the disclosure of which is incorporated herein in its entirety by reference.

### BACKGROUND

### 1. Field

The present disclosure relates to a vehicle terminal and an operation method thereof and, more particularly, to a method of verifying a reliability of an external vehicle and a vehicle terminal therefor.

### 2. Description of the Related Art

Vehicle to everything (V2X) communication such as vehicle to vehicle (V2V) communication which is wireless communication performed between vehicles are becoming more common. To build a more favorable environment for the V2X communication, identification of a highly reliable vehicle is required.

An autonomous vehicle refers to a vehicle equipped with an autonomous driving device that recognizes an environment around the vehicle and a state of the vehicle to control driving of the vehicle based on the environment and the state. With progresses in research on autonomous vehicles, studies on various services that may increase a user's convenience using the autonomous vehicle are also being conducted.

### SUMMARY

An aspect provides a vehicle terminal and an operation method thereof. Technical goals to be achieved through the example embodiments are not limited to the technical goals as described above, and other technical tasks can be inferred from the following example embodiments.

According to an aspect, there is provided an operation method of a vehicle terminal, the method including receiving first information for reliability verification from an external vehicle, transmitting the first information to at least one vehicle in a vicinity of a vehicle, receiving second information acquired through a sensor of the at least one vehicle and corresponding to the first information, from the at least one vehicle, and identifying whether to allow vehicle to vehicle (V2V) communication with the external vehicle by comparing the first information and the second information.

According to another aspect, there is also provided a vehicle terminal including a communicator and a controller configured to receive first information for reliability verification from an external vehicle through the communicator, transmit the first information to at least one vehicle in a vicinity of a vehicle, receive second information acquired through a sensor of the at least one vehicle and corresponding to the first information from the at least one vehicle, and identify whether to allow V2V communication with the external vehicle by comparing the first information and the second information.

According to another aspect, there is also provided a non-volatile computer readable recording medium including a computer program for performing the above-described method.

Specific details of example embodiments are included in the detailed description and drawings.

According to example embodiments, an external vehicle may send incorrect information to a vehicle deliberately or due to malfunctioning of a sensor in the external vehicle. Thus, the vehicle may determine whether the external vehicle is a reliable vehicle by verifying accuracy of first information of the external vehicle based on second information of at least one vehicle. Through this, the vehicle may perform V2V communication with a reliable external vehicle and thus, may process data with increased accuracy. Also, when the vehicle is an autonomous vehicle, the vehicle may reduce a possibility of an accident occurring more effectively by performing the V2V communication with the reliable external vehicle.

Effects are not limited to the aforementioned effects, and other effects not mentioned will be clearly understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 is a block diagram illustrating a wireless communication system to which the methods proposed in the present disclosure are applicable;

FIG. 5 is a diagram illustrating an example of a signal transmission and reception method performed in a wireless communication system;

FIG. 6 illustrates an example of basic operations of an autonomous vehicle and a 5G network in a 5G communication system;

FIG. 7 illustrates an example of basic operations between a vehicle and another vehicle using 5G communication;

FIG. 8 is a flowchart illustrating operations performed by a vehicle, an external vehicle, and at least one vehicle;

FIG. 9 is a flowchart illustrating a vehicle verifying a reliability of an external vehicle by comparing first information and second information;

FIG. 10 illustrates a vehicle verifying a reliability of an external vehicle according to an example embodiment;

FIG. 11 illustrates a vehicle periodically verifying a reliability of a nearby vehicle according to an example embodiment;

FIG. 12 is a flowchart illustrating operations of a vehicle, an external vehicle, and a server;

FIG. 13 is a flowchart illustrating operations of a vehicle and at least one vehicle;

FIG. 14 is a block diagram illustrating a vehicle terminal; and

FIG. 15 is a flowchart illustrating an operation method of a vehicle terminal.

### DETAILED DESCRIPTION

The terms used in the embodiments are selected, as much as possible, from general terms that are widely used at present while taking into consideration the functions obtained in accordance with the present disclosure, but these terms may be replaced by other terms based on intentions of those skilled in the art, customs, emergency of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In addition, in this specification, “artificial Intelligence (AI)” refers to the field of studying artificial intelligence or a methodology capable of making the artificial intelligence, and “machine learning” refers to the field of studying methodologies that define and solve various problems handled in the field of artificial intelligence. The machine learning is also defined as an algorithm that enhances performance for a certain operation through a steady experience with respect to the operation.

An “artificial neural network (ANN)” may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The model parameters refer to parameters determined by learning, and include weights for synaptic connection and deflection of neurons, for example. Then, hyper-parameters refer to parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks is also called deep learning, and the deep learning is a part of the machine learning. In the following description, the machine learning is used as a meaning including the deep learning.

In addition, in this specification, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive in a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described with reference to the drawings.

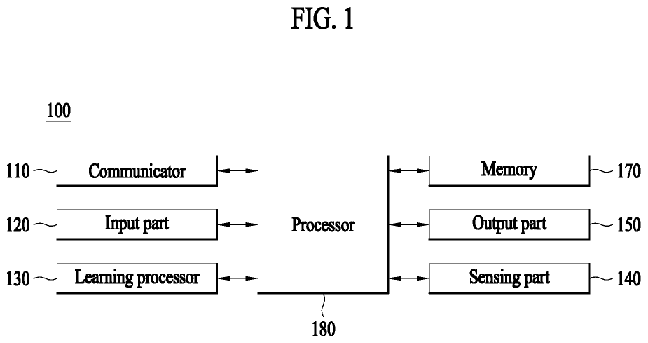

FIG. 1 illustrates an AI device according to an example embodiment.

The AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, a vehicle, or an X reality (XR) device.

Referring to FIG. 1, the AI device 100 may include a communicator 110, an input part 120, a learning processor 130, a sensing part 140, an output part 150, a memory 170, and a processor 180. However, not all components shown in FIG. 1 are essential components of the AI device 100. The AI device may be implemented by more components than those illustrated in FIG. 1, or the AI device may be implemented by fewer components than those illustrated in FIG. 1.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

At this time, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

At this time, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, the learning processor 130 may perform AI processing along with a learning processor 240 of the AI server 200.

At this time, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100, environmental information around the AI device 100, and user information using various sensors.

At this time, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, and a temperature sensor, for example.

The output part 150 may generate, for example, a visual output, an auditory output, or a tactile output.

At this time, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example. The memory 170 may include a storage medium of at least one type among a flash memory, a hard disk, a multimedia card micro type memory, a card type memory (e.g., SD or XD memory), a random access memory (RAM) a static random access memory (SRAM), a read only memory (ROM), an electrically erasable programmable read-only memory (EEPROM), a programmable read-only memory (PROM), a magnetic memory, a magnetic disc, and an optical disc.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

At this time, when connection of an external device is required to perform the determined operation, the processor 180 may generate a control signal for controlling the external device and may transmit the generated control signal to the external device.

The processor 180 may acquire intention information with respect to user input and may determine a user request based on the acquired intention information.

At this time, the processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by the learning processor 130, may have learned by a learning processor 240 of the AI server 200, or may have learned by distributed processing of these processors.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

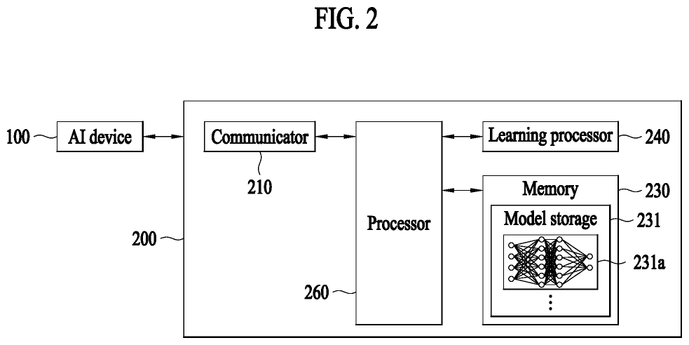

FIG. 2 illustrates an AI server according to an example embodiment.

Referring to FIG. 2, an AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. At this time, the AI server 200 may be included as a constituent element of the AI device 100 so as to perform at least a part of AI processing together with the AI device.

The AI server 200 may include a communicator 210, a memory 230, a learning processor 240, and a processor 260.

The communicator 210 may transmit and receive data to and from an external device such as the AI device 100.

The memory 230 may include a model storage 231. The model storage 231 may store a model (or an artificial neural network 231a) which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

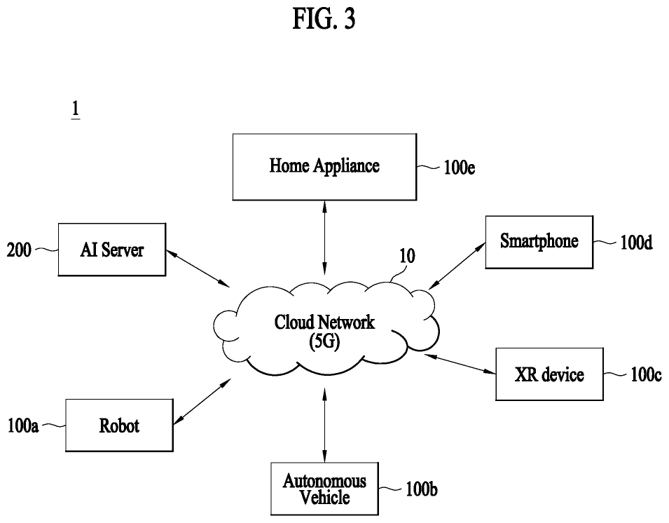

FIG. 3 illustrates an AI system according to an example embodiment.

Referring to FIG. 3, in the AI system 1, at least one of the AI server 200, a robot 100a, an autonomous vehicle 100b, an XR device 100c, a smart phone 100d, and a home appliance 100e is connected to a cloud network 10. Here, the robot 100a, the autonomous vehicle 100b, the XR device 100c, the smart phone 100d, and the home appliance 100e, to which AI technologies are applied, may be referred to as AI devices 100a to 100e.

The cloud network 10 may constitute a part of a cloud computing infra-structure, or may refer to a network present in the cloud computing infra-structure. Here, the cloud network 10 may be configured using a 3G network, a 4G or long term evolution (LTE) network, or a 5G network, for example.

That is, respective devices 100a to 100e and 200 constituting the AI system 1 may be connected to each other via the cloud network 10. In particular, respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smart phone 100d, and the home appliance 100e, which are AI devices constituting the AI system 1, via cloud network 10, and may assist at least a part of AI processing of connected the AI devices 100a to 100e.

At this time, instead of the AI devices 100a to 100e, the AI server 200 may cause an artificial neural network to learn according to a machine learning algorithm, and may directly store a learning model or may transmit the learning model to the AI devices 100a to 100e.

At this time, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various example embodiments of the AI devices 100a to 100e, to which the above-described technology is applied, will be described. Here, the AI devices 100a to 100e illustrated in FIG. 3 may be specific example embodiments of the AI device 100 illustrated in FIG. 1.

The autonomous vehicle 100b may be realized into a mobile robot, a vehicle, or an unmanned air vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 1200b, but may be a separate hardware element outside the autonomous vehicle 1200b so as to be connected thereto.

The autonomous vehicle 100b may acquire information on the state of the autonomous vehicle 1200b using sensor information acquired from various types of sensors, may detect or recognize the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 1200a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

At this time, the autonomous vehicle 100b may generate a result using the learning model to perform an operation, but may transmit sensor information to an external device such as the AI server 200 and receive a result generated by the external device to perform an operation.

The autonomous vehicle 100b may determine a movement route and a driving plan using at least one of map data, object information detected from sensor information, and object information acquired from an external device, and a drive part may be controlled to drive the autonomous vehicle 100b according to the determined movement route and driving plan.

The map data may include object identification information for various objects arranged in a space (e.g., a road) along which the autonomous vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, the autonomous vehicle 100b may perform an operation or may drive by controlling the drive part based on user control or interaction. At this time, the autonomous vehicle 100b may acquire interactional intention information depending on a user operation or voice expression, and may determine a response based on the acquired intention information to perform an operation.

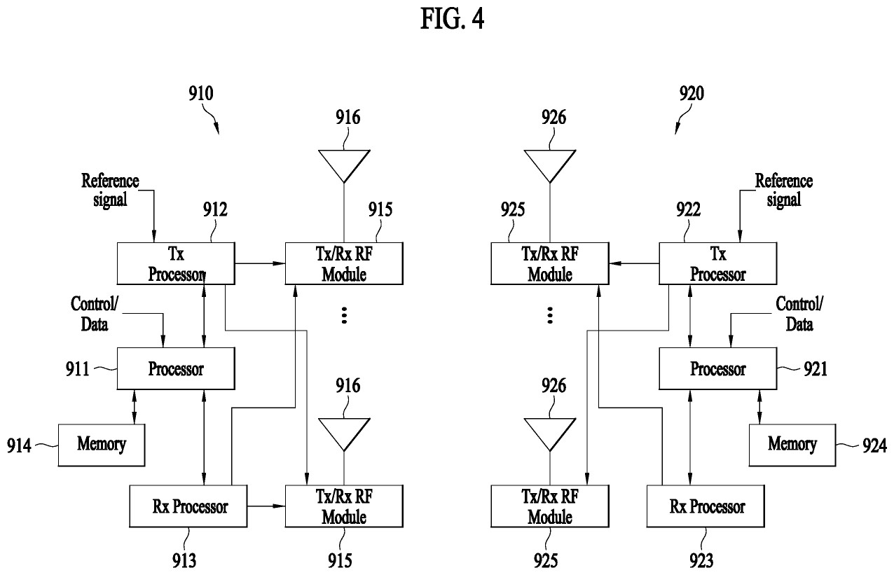

FIG. 4 is a block diagram illustrating a wireless communication system to which the methods proposed in the present disclosure are applicable.

Referring to FIG. 4, a device including an autonomous vehicle, hereinafter also referred to as “autonomous driving device”, may be defined as a first communication device as indicated by a reference numeral 910. A processor 911 may perform a detailed operation for autonomous driving.

A 5G network including another vehicle that communicates with the autonomous driving device may be defined as a second communication device, as indicated by a reference numeral 920. A processor 921 may perform a detailed operation for autonomous driving.

The 5G network may also be referred to as the first communication device and the autonomous driving device may also be referred to as the second communication device.

The first communication device or the second communication device may be, for example, a base station, a network node, a transmitting terminal, a receiving terminal, a wireless device, a wireless communication device, and an autonomous driving device.

A terminal or user equipment (UE) may include, for example, a vehicle, a mobile phone, a smartphone, a laptop computer, a digital broadcast terminals, a personal digital assistant (PDA), a portable multimedia player (PMP), a navigator, a slate PC, a tablet PC, an ultrabook, and a wearable device such as a smartwatch, a smart glass, and a head mounted display (HMD), and the like. For example, the HMD may be a display device to be worn on a head. For example, the HMD may be used to implement a virtual reality (VR), an augmented reality (AR), or a mixed reality (MR). Referring to FIG. 4, the first communication device 910 and the second communication device 920 may include the processors 911 and 921, the memory 914 and 924, one or more Tx/Rx radio frequency (RF) modules 915 and 925, Tx processors 912 and 922, Rx processors 913 and 923, and antennas 916 and 926. The Tx/Rx module may also be referred to as a transceiver. Each of the Tx/Rx RF modules 915 and 925 may transmit a signal using the antennas 916 and 926. The processor may implement the functions, processes, and/or methods described herein. The processor 921 may be associated with the memory 924 that stores a program code and data. The memory may also be referred to as a computer-readable medium. Specifically, in downlink (DL) communication, for example, communication from the first communication device to the second communication device, the Tx processor 912 may implement various signal processing functions for a layer L1, that is, a physical layer. The Rx processor may implement various signal processing functions of the layer L1, that is, a physical layer.

Uplink (UL) communication, for example, communication from the second communication device to the first communication device may be processed in the first communication device 910 in a manner similar to that described with respect to the function of the receiver in the second communication device 920. Each of the Tx/Rx modules 925 may receive a signal using the antenna 926. Each of the Tx/Rx modules may provide a radio frequency (RF) carrier wave and information to the Rx processor 923. The processor 921 may be associated with the memory 924 that stores a program code and data. The memory may also be referred to as a computer-readable medium.

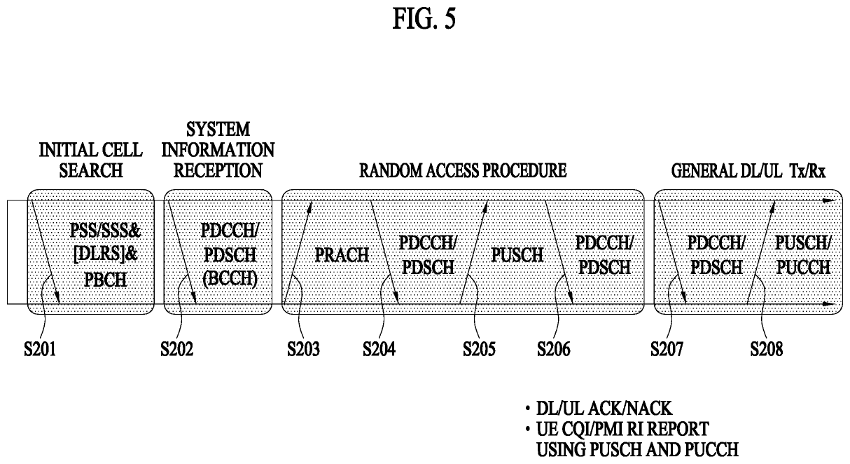

FIG. 5 illustrates an example of a signal transmission and reception method performed in a wireless communication system.

Referring to FIG. 5, in operation S201, when UE is powered on or enters a new cell, the UE performs an initial cell search procedure such as acquisition of synchronization with a BS. To this end, the UE may adjust synchronization with the BS by receiving a primary synchronization channel (P-SCH) and a secondary synchronization channel (S-SCH) from the BS and acquire information such as a cell identifier (ID). In an LTE system and a new radio (NR) system, the P-SCH and the S-SCH may also be referred to as a primary synchronization signal (PSS) and a secondary synchronization signal (SSS), respectively. After the initial cell search, the UE may acquire in-cell broadcast information by receiving a physical broadcast channel from the BS. In the initial cell search procedure, the UE may monitor a DL channel state by receiving a downlink reference signal (DL RS). When the initial cell search procedure is terminated, in operation S202, the UE may acquire more detailed system information by receiving a physical downlink control channel (PDCCH) and a physical downlink shared channel (PDSCH) based on information carried on the PDCCH.

Meanwhile, if the UE initially accesses the BS or if radio resources for signal transmission are absent, the UE may perform a random access procedure with respect to the BS in operations S203 through S206. To this end, the UE may transmit a specific sequence as a preamble through a physical random access channel (PRACH) in operations S203 and S205 and receive a random access response (RAR) message for the preamble through the PDCCH and the PDSCH corresponding to the PDCCH in operations S204 and S206. In the case of a contention-based RACH, the UE may additionally perform a contention resolution procedure.

After performing the above procedures, the UE may perform PDCCH/PDSCH reception in operation S207 and perform physical uplink shared channel (PUSCH)/physical uplink control channel (PUCCH) transmission in operation S208, as a general UL/DL signal transmission procedure. For example, the UE may receive downlink control information (DCI) through the PDCCH. The UE may monitor a set of PDCCH candidates in monitoring occasions set in one or more control element sets (CORESETs) on a serving cell based on corresponding search space configurations. The set of PDCCH candidates to be monitored by the UE may be defined in terms of search space sets. The search space set may be a common search space set or a UE-specific search space set. The CORESET may include a set of (physical) resource blocks having a time duration of one to three orthogonal frequency division multiplexing (OFDM) symbols. A network may set the UE to have a plurality of CORESETs. The UE may monitor PDCCH candidates in one or more search space sets. Here, the monitoring may indicate attempting to decode the PDCCH candidate(s) in the search space. When the UE succeeds in decoding one of the PDCCH candidates in the search space, the UE may determine that the PDCCH is detected in the corresponding PDCCH candidate and perform PDSCH reception or PUSCH transmission based on the DCI in the detected PDCCH. The PDCCH may be used to schedule DL transmission on the PDSCH and UL transmission on the PUSCH. Here, the DCI on the PDCCH may include downlink assignment, that is, a downlink grant (DL grant) including at least a modulation and coding format and resource allocation information in association with a downlink shared channel, or an uplink grant (UL grant) including a modulation and coding formal and resource allocation information in association with an uplink shared channel.

An initial access (IA) procedure performed in a 5G communication system will be further described with reference to FIG. 5.

UE may perform cell search, system information acquisition, beam alignment for initial access, DL measurement, and the like based on a synchronization signal block (SSB). The term “SSB” may be interchangeably used with the term “synchronization signal/physical broadcast channel (SS/PBCH) block”.

The SSB may include a PSS, an SSS, and a PBCH. The SSB may include four consecutive OFDM symbols. For each of the OFDM symbols, the PSS, the PBCH, the SSS/PBCH, or the PBCH may be transmitted. The PSS and the SSS may each include one OFDM symbols and 127 subcarriers. The PBCH may include three OFDM symbols and 576 subcarriers.

The cell search may indicate a process in which the UE acquires time/frequency synchronization of a cell and detect a cell ID, for example, a physical layer cell ID (PCI) of the cell. The PSS may be used to detect a cell ID in a cell ID group. The SSS may be used to detect the cell ID group. The PBCH may be used for SSB (time) index detection and half-frame detection.

336 cell ID groups may be present. Three cell IDs may belong to each of the cell ID groups. Information on a cell ID group to which a cell ID of a cell belongs may be provided/acquired through an SSS of the cell. Information on the cell ID among 336 cells in the cell ID may be provided/acquired through the PSS.

The SSB may be periodically transmitted based on an SSB periodicity. When performing the initial cell search, a basic SSB periodicity assumed by the UE may be defined as 20 ms. After the cell connection, the SSB periodicity may be set to one of 5 ms, 10 ms, 20 ms, 40 ms, 80 ms, and 160 ms by a network, for example, the BS.

Acquisition of system information (SI) will be described as follows.

The SI may be divided into a master information block (MIB) and a plurality of system information blocks (SIBs). The SI other than the MIB may be referred to as remaining minimum system information (RMSI). The MIB may include information/parameter for monitoring the PDCCH that schedules the PDSCH carrying SystemInformationBlock1 (SIB1), and may be transmitted by the BS through the PBCH of the SSB. The SIB1 may include information associated with availabilities and scheduling (e.g., a transmission period and an SI-window size) of remaining SIBs (hereinafter, referred to as “SIBx”, x being an integer greater than or equal to 2). The SIBx may be included in an SI message and transmitted through the PDSCH. Each SI message may be transmitted within a time window, that is, an SI-window occurring periodically.

A random access (RA) procedure performed in the 5G communication system will be further described with reference to FIG. 5.

The RA procedure may be used for various purposes. For example, the RA procedure may be used for network initial access, handover, and UE-triggered UL data transmission. The UE may acquire UL synchronization and UL transmission resources through the RA procedure. The RA procedure may include a contention-based RA procedure and a contention-free RA procedure. A detailed process of the contention-based RA procedure is described as follows.

The UE may transmit an RA preamble through the PRACH as Msg1 of the RA procedure in the UL communication. RA preamble sequences having two different lengths may be supported. A large sequence length of 839 may be applied to subcarrier spacing of 1.25 and 5 kilohertz (kHz). A small sequence length of 139 may be applied to subcarrier spacing of 15 kHz, 30 kHz, 60 kHz, and 120 kHz.

When the BS receives the RA preamble from the UE, the BS may transmit a random access response (RAR) message Msg2 to the UE. The PDCCH that schedules the PDSCH carrying the RAR may cyclic redundancy check (CRC)-masked with an RA radio network temporary identifier (RA-RNTI), and then transmitted. The UE may detect the PDCCH masked with the RA-RNTI and receive the RAR from the PDSCH scheduled by the DCI carried by the PDCCH. The UE may verify whether a preamble transmitted by the UE, that is, RAR information for the Msg1 is present in the RAR. Whether RA information for the Msg1 transmitted by the UE is present may be determined based on whether an RA preamble ID for the preamble transmitted by the UE is present. When a response to the Msg1 is absent, the UE may retransmit an RACH preamble within a predetermined number of times while performing power ramping. The UE may calculate PRACH transmitting power for retransmitting a preamble based on a most recent path loss and a power ramping counter.

The UE may perform the UL transmission on the uplink shared channel based on the RAR information as transmission of Msg3 in the random access procedure. The Msg3 may include an RRC connection request and a UE identifier. As a response to the Msg3, the network may transmit Msg4, which may treated as a contention resolution message on the DL. By receiving the Msg4, the UE may enter an RRC-connected state.

Ultra-reliable and low latency communication (URLLC) transmission defined in the NR may be transmission associated with: (1) a relatively low traffic amount; (2) a relatively low arrival rate; (3) an ultra-low latency requirement (e.g., 0.5 and 1 ms); (4) a relatively short transmission duration (e.g., 2 OFDM symbols); and (5) an urgent service/message. In the case of the UL, to satisfy a more stringent latency requirement, transmission of a specific type of traffic, for example, URLLC may be multiplexed with another transmission scheduled in advance, for example, enhanced Mobile Broadband communication (eMBB). As one method related thereto, information indicating that preemption is to be performed on predetermined resources is transmitted to the UE scheduled in advance, so that URLLC UE uses the corresponding resources for UL transmission.

In a case of the NR, dynamic resource sharing between the eMBB and the URLLC may be supported. eMBB and URLLC services may be scheduled on non-overlapping time/frequency resources. The URLLC transmission may occur on resources scheduled with respect to ongoing eMBB traffic. eMBB UE may not know whether PDSCH transmission of the corresponding UE is partially punctured. Also, due to corrupted coded bits, the UE may not decode the PDSCH. Considering this, a preemption indication may be provided in the NR. The preemption indication may also be referred to as an interrupted transmission indication.

In association with the preemption indication, the UE may receive DownlinkPreemption IE through RRC signaling from the BS. When the UE receives the DownlinkPreemption IE, the UE may be configured with an INT-RNTI provided by a parameter int-RNTI in the DownlinkPreemption IE for monitoring of the PDCCH conveying a DCI format 2_1. The UE may be additionally configured to have a set of serving cells by INT-ConfigurationPerServing Cell including a set of serving cell indices provided by servingCellID and a corresponding set of positions for fields in the DCI format 2_1 by positionInDCI, configured to have information payload size for the DCI format 2_1 by dci-PayloadSize, and configured to have an indication granularity of time-frequency resources by timeFrequencySect.

The UE may receive the DCI format 2_1 from the BS based on the DownlinkPreemption IE.

When the UE detects the DCI format 2_1 for a serving cell in a set of serving cells, the UE may assume that no transmission to the UE is performed in symbols and PRBs indicated by the DCI format 2_1 among a set of symbols and a set of PRBs corresponding to the last monitoring period of a monitoring period to which the DCI format 2_1 belongs. For example, the UE may determine that a signal in the time-frequency resources indicated by the preemption is not the DL transmission scheduled for the UE and thus, decode data based on signals received in remaining resource areas.

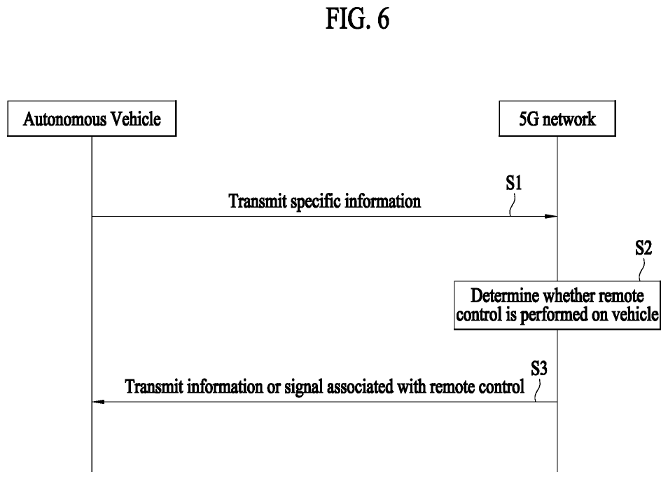

FIG. 6 illustrates an example of basic operations of an autonomous vehicle and a 5G network in a 5G communication system.

In operation S1, the autonomous vehicle may transmit specific information to a 5G network. The specific information may include autonomous driving-related information. In operation S2, the 5G network may determine whether a remote control is performed on the vehicle. Here, the 5G network may include a server or a module for performing an autonomous driving-related remote control. In operation S3, the 5G network may transmit information or a signal associated with the remote control to the autonomous vehicle.

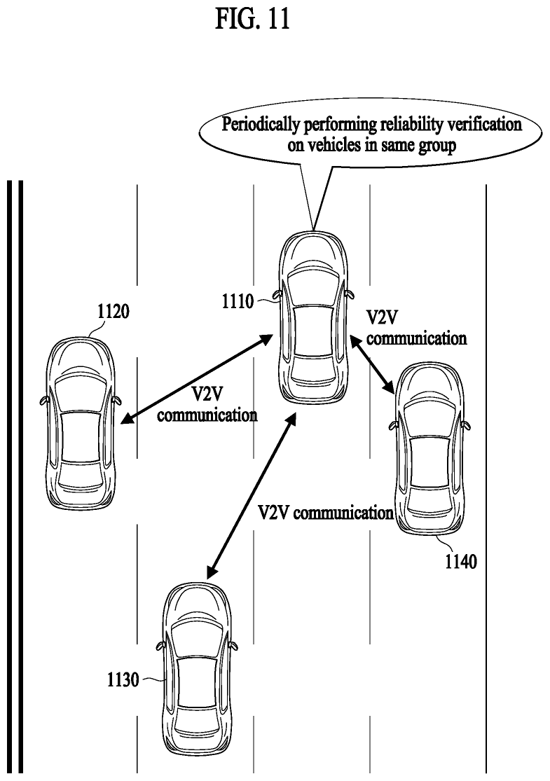

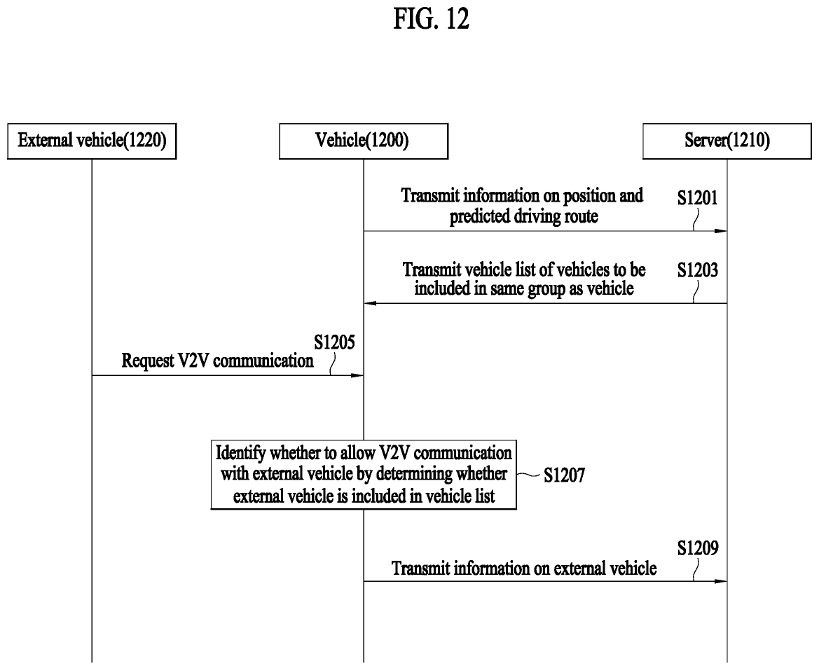

Hereinafter, an operation of the autonomous vehicle using 5G communication will be described in detail with reference to FIGS. 11 and 12 and the aforementioned wireless communication technologies such as a beam management (BM) procedure, URLLC, massive Machine Type Communication (mMTC), and the like.

A basic procedure of an application operation to which the method proposed in the present disclosure and eMBB technology of the 5G communication are applicable will be described.

Likewise operations S1 and S3 of FIG. 6, to transmit and receive a signal, information, and the like to and from the 5G network, the autonomous vehicle may perform an initial access procedure and a random access procedure in connection with the 5G network before operation S1 of FIG. 6 is performed.

Specifically, the autonomous vehicle may perform the initial access procedure in connection with the 5G network based on an SSB to acquire a DL synchronization and system information. In the initial access procedure, a BM process and a beam failure recovery process may be added. Also, a quasi-co location (QCL) relationship may be added in a process of receiving a signal from the 5G network by the autonomous vehicle.

The autonomous vehicle may perform the random access procedure in connection with the 5G network for acquisition of a UL synchronization and/or UL transmission. The 5G network may transmit a UL grant for scheduling transmission of specific information to the autonomous vehicle. The autonomous vehicle may transmit the specific information to the 5G network based on the UL grant. In addition, the 5G network may transmit a DL grant for scheduling transmission of a result of 5G processing for the specific information to the autonomous vehicle. The 5G network may transmit information or a signal associated with the remote control to the autonomous vehicle based on the DL grant.

A basic procedure of an application operation to which URLLC technology of the 5G communication and the method proposed in the present disclosure are applicable will be described as follows.

As described above, the autonomous vehicle may perform the initial access procedure and/or the random access procedure in connection with the 5G network, and then receive DownlinkPreemption IE from the 5G network. The autonomous vehicle may receive DownlinkPreemption IE a DCI format 2_1 including a preemption indication from the 5G network. The autonomous vehicle may not perform, expect, or assume reception of eMBB data on resources, for example, a PRB and/or an OFDM symbol indicated by the preemption indication. Thereafter, when specific information is to be transmitted, the autonomous vehicle may receive the UL grant from the 5G network.

A basic procedure of an application operation to which mMTC technology of the 5G communication and the method proposed in the present disclosure are applicable will be described as follows.

Among operations of FIG. 6, a part changed according to the application of the mMTC technology will be mainly described.

Referring to FIG. 6, in operation S1, the autonomous vehicle may receive a UL grant from the 5G network to transmit specific information to the 5G network. Here, the UL grant may include information on a number of repetitions for transmission of the specific information. The specific information may be repetitively transmitted based on the information on the number of repetitions. That is, the autonomous vehicle may transmit the specific information to the 5G network based on the UL grant. The repetitive transmission of the specific information may be performed through frequency hopping. For example, first transmission of the specific information may be performed on a first frequency resource and second transmission of the specific information may be performed on a second frequency resource. The specific information may be transmitted through a narrowband of a resource block 1RB or a resource block 6RB.

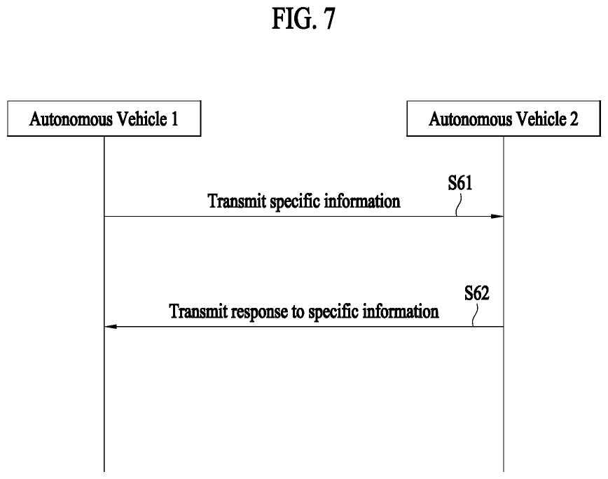

FIG. 7 illustrates an example of basic operations performed between a vehicle and another vehicle using 5G communication.

In operation S61, a first vehicle may transmit specific information to a second vehicle. In operation S62, the second vehicle may transmit a response to the specific information to the first vehicle.

A configuration of application operations between a vehicle and another vehicle may vary based on whether the 5G network is involved directly (sidelink communication transmitting mode 3) or indirectly (sidelink communication transmitting mode 4) with the specific information and resource allocation of a response to the specific information.

Application operations performed between a vehicle and another vehicle using the 5G communication will be described as follows.

First, how the 5G network is directly involved in resource allocation of signal transmission/reception between vehicles will be described.

The 5G network may transmit a DCI format 5A for scheduling of mode-3 transmission (PSCCH and/or PSSCH transmission) to the first vehicle. Here, a physical sidelink control channel (PSCCH) may be a 5G physical channel for scheduling transmission of specific information. Also, a physical sidelink shared channel (PSSCH) may be a 5G physical channel for transmitting the specific information. The first vehicle may transmit an SCI format 1 for scheduling transmission of specific information to the second vehicle on the PSCCH. Also, the first vehicle may transmit the specific information to the second vehicle on the PSSCH.

Next, how the 5G network is indirectly involved in resource allocation of signal transmission/reception between vehicles will be described.

The first vehicle may sense a resource for the mode-4 transmission in a first window. The first vehicle may select a resource for the mode-4 transmission in a second window based on a result of the sensing. Here, the first window may be a sensing window and the second window may be a selection window. The first vehicle may transmit the SCI format 1 for scheduling transmission of specific information to the second vehicle on the PSCCH based on the selected resource. Also, the first vehicle may transmit the specific information to the second vehicle on the PSSCH.

The autonomous vehicle performing at least one of V2V communication and V2X communication may transmit and receive information on a channel of the corresponding communication. For example, for the V2V communication and the V2X communication, channels for sidelinks corresponding to the communication methods may be allocated, so that the autonomous vehicle transmits and receives information on the corresponding channel to and from a server or another vehicle. Also, a shared channel for a sidelink may be allocated, so that a signal for at least one of the V2V communication and the V2X communication is transmitted and received on the corresponding channel. In order to perform at least one of the V2V communication and the V2X communication, the autonomous vehicle may acquire a separate identifier of the corresponding communication from at least one of a base station, a network, and another vehicle. The autonomous vehicle may perform the V2V communication and the V2X communication based on information on the acquired separate identifier.

Information transmitted through broadcasting may be transmitted on a separate channel for broadcasting. Node-to-node communication may be performed on a channel different from the channel for broadcasting. Also, information for controlling the autonomous vehicle may be transmitted on a channel for URLLC.

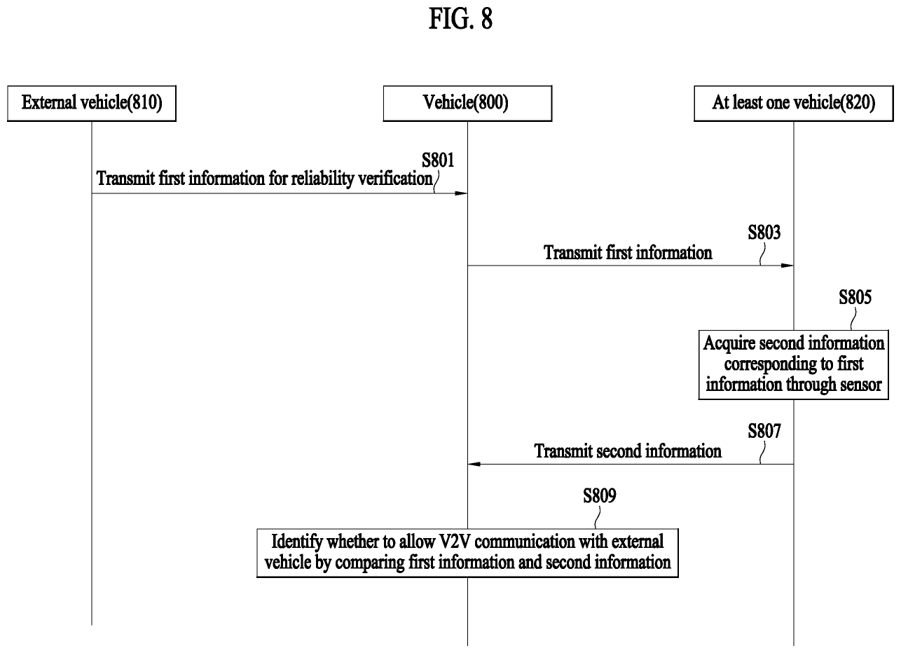

FIG. 8 is a flowchart illustrating operations performed by a vehicle, an external vehicle, and at least one vehicle.

In operation S801, an external vehicle 810 may transmit first information for reliability verification to a vehicle 800. The vehicle 800 may request information for reliability verification from the external vehicle 810. In response to the requesting of the vehicle 800, the external vehicle 810 may transmit first information for reliability verification to the vehicle 800. The external vehicle 810 may transmit a vehicle to vehicle (V2V) message including the first information to the vehicle 800. The first information may include at least one of position information of a specific vehicle and velocity information of the specific vehicle. The first information may be, for example, position information or velocity information of the external vehicle 810. In addition, the first information may be information on an object around the external vehicle 810 or information on a circumstance around the external vehicle 810. The first information may be, for example, information on whether an accident occurs around the external vehicle 810.

As an example, the external vehicle 810 may request the vehicle 800 to perform V2V communication. The vehicle 800 may request information for reliability verification from the external vehicle 810. In response to the requesting of the vehicle 800, the external vehicle 810 may transmit the first information for reliability verification to the vehicle 800. As another example, the vehicle 800 may perform the V2V communication with the external vehicle 810. In this example, when a reliability verification period of the external vehicle 810 elapses, the vehicle 800 may request information for reliability verification from the external vehicle 810 and receive the first information for reliability verification from the external vehicle 810.

The vehicle 800 may receive the V2V message from the external vehicle 810 and identify the first information for reliability verification in the V2V message.

In operation S803, the vehicle 800 may transmit the first information received from the external vehicle 810 to at least one vehicle 820. The vehicle 800 may transmit the V2V message including the first information to the at least one vehicle 820. The V2V message transmitted by the vehicle 800 to the at least one vehicle 820 may include the first information and information for requesting information for verifying accuracy of the first information. When the at least one vehicle 820 includes a first vehicle and a second vehicle, the vehicle 800 may transmit the V2V message including the first information received from the external vehicle 810 to each of the first vehicle and the second vehicle.

The at least one vehicle 820 may be located in a vicinity of the vehicle 800. Also, the at least one vehicle 820 may be a vehicle for which the vehicle 800 is reliable. Specifically, the at least one vehicle 820 may be a vehicle for which the vehicle 800 is reliable according to a reliability verification result of the vehicle 800. The at least one vehicle 820 and the vehicle 800 may be included in a same group. The at least one vehicle 820 and the vehicle 800 may periodically acquire information on the same group from a server.

In operation S805, the at least one vehicle 820 may acquire second information corresponding to the first information through a sensor. Specifically, the at least one vehicle 820 may identify the first information transmitted from the vehicle 800 and acquire the second information corresponding to the first information through the sensor. For example, when the first information is position information of a specific vehicle, the at least one vehicle 820 may measure a position of the specific vehicle using the sensor. In this example, the at least one vehicle 820 may acquire information on the measured position as the second information.

The at least one vehicle 820 may compare the first information and the second information to verify the accuracy of the first information. Specifically, the at least one vehicle 820 may determine a difference between the first information and the second information. When the determined difference exceeds a predetermined threshold, the at least one vehicle 820 may determine that the accuracy of the first information is relatively low. When the determined difference does not exceed the threshold, the at least one vehicle 820 may determine that the accuracy of the first information is relatively high.

In operation S807, the at least one vehicle 820 may transmit the second information acquired in operation S805 to the vehicle 800. The at least one vehicle 820 may transmit a V2V message including the second information to the vehicle 800.

The at least one vehicle 820 may verify the accuracy of the first information by comparing the first information and the second information, and transmit an accuracy verification result to the vehicle 800.

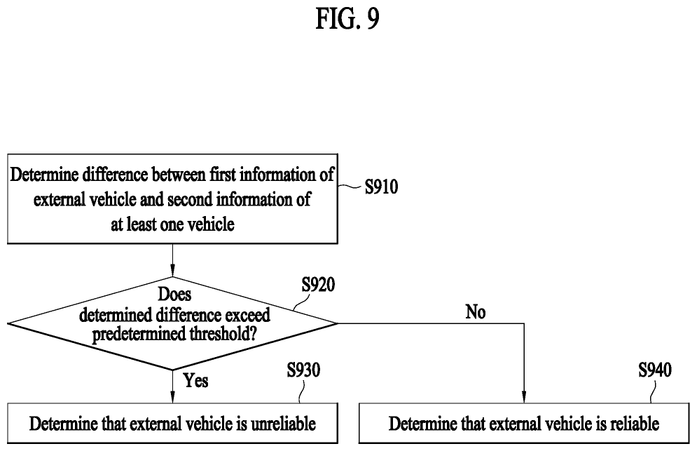

In operation S809, the vehicle 800 may identify whether to allow the V2V communication with the external vehicle 810 by comparing the first information and the second information. The vehicle 800 may determine a difference between the first information of the external vehicle 810 and the second information of the at least one vehicle 820, and determine whether to allow the V2V communication with the external vehicle 810 based on the determined difference. When the determined difference is greater than a predetermined threshold, the vehicle 800 may disallow the V2V communication with the external vehicle 810. When the determined difference is less than the threshold, the vehicle 800 may allow the V2V communication with the external vehicle 810. Related description will be made in detail with reference to FIG. 9.

The vehicle 800 may receive the accuracy verification result of the first information from the at least one vehicle 820 and identify whether to allow the V2V communication with the external vehicle 810 based on the accuracy verification result. Specifically, when the accuracy verification result of the at least one vehicle 820 indicates that the accuracy is relatively high, the vehicle 800 may allow the V2V communication with the external vehicle 810. When the accuracy verification result of indicates that the accuracy is relatively low, the vehicle 800 may disallow the V2V communication with the external vehicle 810.

The vehicle 800 may identify the first information of the external vehicle 810 and acquire the second information corresponding to the first information through the sensor of the vehicle 800. The vehicle 800 may compare the first information and the second information and allow the V2V communication with the external vehicle 810.

FIG. 9 is a flowchart illustrating a vehicle verifying a reliability of an external vehicle by comparing first information and second information.

In operation S910, the vehicle 800 may determine a difference between first information of an external vehicle and second information of at least one vehicle. Specifically, the vehicle 800 may determine a difference between the first information of the external vehicle requesting the V2V communication and the second information of at least one vehicle for which the vehicle 800 is reliable. When the at least one vehicle includes a first vehicle and a second vehicle, the vehicle 800 may determine a difference between the first information of the external vehicle and 2-1^{st} information of the first vehicle, and determine a difference between the first information of the external vehicle and 2-2^{nd} information of the second vehicle.

In one example, when first information of the external vehicle is information indicating a first position of a specific object, the at least one vehicle may measure a position of the specific object using a sensor of the at least one vehicle, thereby acquiring second information indicating a second position of the specific object. The vehicle 800 may determine a difference between the first position and the second position. The vehicle 800 may determine a distance between the first position and the second position to be the difference between the first information and the second information.

In another example, when first information of the external vehicle is information indicating a first velocity of a specific object, the at least one vehicle may measure a velocity of the specific object using the sensor of the at least one vehicle, thereby acquiring second information indicating a second velocity of the specific object. The vehicle 800 may determine a difference between the first velocity and the second velocity. The vehicle 800 may determine a difference between the first velocity and the second velocity to be the difference between the first information and the second information.

In operation S920, the vehicle 800 may determine whether the difference determined in operation S910 exceeds a predetermined threshold. When the at least one vehicle includes the first vehicle and the second vehicle, the vehicle 800 may determine whether the difference between the first information of the external vehicle and the 2-1^{st} information of the first vehicle exceeds the threshold, and determine whether the difference between the first information of the external vehicle and the 2-2^{nd} information of the second vehicle exceeds the threshold. Alternatively, the vehicle 800 may determine second information of the at least one vehicle based on the 2-1^{st} information of the first vehicle and the 2-2^{nd} information of the second vehicle, and determine whether a difference between the determined second information and the first information of the external vehicle exceeds a predetermined threshold. For example, when the second information is velocity information, the vehicle 800 may determine a velocity measured by the first vehicle and an average of velocities measured by the second vehicle to be the second information of the at least one vehicle.

When the first information of the external vehicle is information indicating the first position of the specific object and the second information of the at least one vehicle is information indicating the second position of the specific object, the vehicle 800 may determine whether a distance between the first position and the second position exceeds a predetermined distance. The predetermined distance may be, for example, 1.5 meters (m) to 2.0 m, 20 m, or 40 m. The predetermined distance may vary based on whether the external vehicle or the at least one vehicle includes a global positioning system (GPS) error correction system. When the external vehicle or the at least one vehicle includes the GPS error correction system, the predetermined distance may be 1.5 m to 2 m. When the external vehicle and the at least one vehicle do not include the GPS error correction system, the predetermined distance may be 20 m.

When the first information of the external vehicle is information indicating the first velocity of the specific object and the second information of the at least one vehicle is information indicating the second velocity of the specific object, the vehicle 800 may determine whether a difference between the first velocity and the second velocity exceeds a predetermined velocity. The predetermined velocity may be, for example, 2 kilometers per hour (km/h) or 10 km/h.

As a determination result of operation S920, when the determined difference exceeds the threshold, the vehicle 800 may determine that the external vehicle is unreliable in operation S930. In other words, when the determined difference exceeds the threshold as a determination result of operation S920, the vehicle 800 may determine that the first information of the external vehicle is inaccurate. Thus, the vehicle 800 may not allow the V2V communication with the external vehicle which is unreliable.

When the vehicle 800 determines that the external vehicle is unreliable, the vehicle 800 may allow the V2V communication with the external vehicle in one direction. For example, the vehicle 800 may transmit a V2V message including information on the vehicle 800 to the external vehicle, and may not receive a V2V message from the external vehicle.

In the case in which the at least one vehicle includes the first vehicle and the second vehicle, the vehicle 800 may determine that the external vehicle is unreliable when at least one of the difference between the first information of the external vehicle and the 2-1^{st} information of the first vehicle and the difference between the first information of the external vehicle and the 2-2^{nd} information of the second vehicle exceeds the threshold.

As a determination result of operation S920, when the determined difference does not exceed the threshold, the vehicle 800 may determine that the external vehicle is reliable in operation S940. In other words, when the determined difference does not exceed the threshold as a determination result of operation S920, the vehicle 800 may determine that the first information of the external vehicle is accurate. Thus, the vehicle 800 may allow the V2V communication with the external vehicle which is reliable.

In the case in which the at least one vehicle includes the first vehicle and the second vehicle, the vehicle 800 may determine that the external vehicle is reliable when each of the difference between the first information of the external vehicle and the 2-1^{st} information of the first vehicle and the difference between the first information of the external vehicle and the 2-2^{nd} information of the second vehicle does not exceed the threshold.

The external vehicle may send incorrect information to the vehicle 800 deliberately or due to malfunctioning of a sensor in the external vehicle. Thus, the vehicle 800 may determine whether the external vehicle is a reliable vehicle by verifying the accuracy of the first information of the external vehicle based on the second information of the at least one vehicle. Through this, the vehicle 800 may perform the V2V communication with the reliable external vehicle and thus, may process data with increased accuracy. Also, when the vehicle 800 is an autonomous vehicle, the vehicle 800 may reduce a possibility of an accident occurring more effectively by performing the V2V communication with the reliable external vehicle.

In addition, the vehicle 800 may reduce a data throughput of the vehicle 800 by verifying the accuracy of the first information of the external vehicle based on the second information of the at least one vehicle which is reliable.

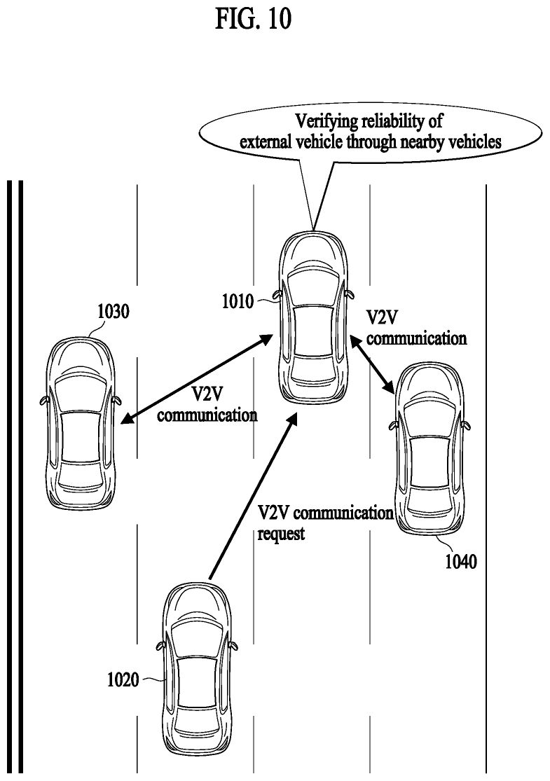

FIG. 10 illustrates a vehicle verifying a reliability of an external vehicle according to an example embodiment.

A vehicle 1010 may receive a V2V communication request from an external vehicle 1020. The vehicle 1010 may request information for reliability verification from the external vehicle 1020 and receive first information for reliability verification from the external vehicle 1020. For example, the vehicle 1010 may receive first information indicating a position of the external vehicle 1020.

The vehicle 1010 may transmit the first information of the external vehicle 1020 to nearby vehicles 1030 and 1040 which are reliable. The vehicle 1010 and the nearby vehicles 1030 and 1040 may have a same group identification (ID) and perform V2V communication.

The nearby vehicle 1030 may identify the first information of the external vehicle 1020 and acquire second information corresponding to the first information through a sensor. For example, when the first information is position information of the external vehicle 1020, the nearby vehicle 1030 may acquire the second information by measuring a position of the external vehicle 1020 using the sensor. Likewise, the nearby vehicle 1040 may identify the first information of the external vehicle 1020 and acquire second information corresponding to the first information using a sensor. Each of the nearby vehicles 1030 and 1040 may transmit the acquired second information to the vehicle 1010.

The vehicle 1010 may compare the first information of the external vehicle 1020 to the second information of each of the nearby vehicles 1030 and 1040 and identify whether to allow the V2V communication with the external vehicle 1020. Specifically, the vehicle 1010 may determine whether a difference between the first information of the external vehicle 1020 and the second information of the nearby vehicle 1030 exceeds a predetermined threshold, and determine whether a difference between the first information of the external vehicle 1020 and the second information of the nearby vehicle 1040 exceeds the threshold. When at least one of the difference between the first information of the external vehicle 1020 and the second information of the nearby vehicle 1030 and the difference between the first information of the external vehicle 1020 and the second information of the nearby vehicle 1040 exceeds the threshold, the vehicle 1010 may determine that the external vehicle 1020 is unreliable and thus, disallow the V2V communication with the external vehicle 1020. When each of the difference between the first information of the external vehicle 1020 and the second information of the nearby vehicle 1030 and the difference between the first information of the external vehicle 1020 and the second information of the nearby vehicle 1040 does not exceed the threshold, the vehicle 1010 may determine that the external vehicle 1020 is reliable and thus, allow the V2V communication with the external vehicle 1020.

FIG. 11 illustrates a vehicle periodically verifying a reliability of a nearby vehicle according to an example embodiment.

A vehicle 1110 may perform V2V communication with nearby vehicles 1120, 1130, and 1140. The vehicle 1110 and the nearby vehicles 1120, 1130, and 1140 may have a same group ID.

The vehicle 1110 may periodically perform reliability verification on the nearby vehicles 1120, 1130, and 1140. Specifically, the vehicle 1110 may determine whether a predetermined period elapses after the reliability verification is performed on each of the nearby vehicles 1120, 1130, and 1140, and perform reliability reverification on each of the nearby vehicles 1120, 1130, and 1140.

When a reliability verification period of the nearby vehicle 1120 elapses, the vehicle 1110 may request information for reliability verification from the nearby vehicle 1120 and receive the first information for reliability verification from the nearby vehicle 1120. For example, the vehicle 1110 may receive first information indicating a velocity of the nearby vehicle 1120. In this example, the vehicle 1110 may transmit the first information of the nearby vehicle 1120 to the nearby vehicles 1130 and 1140. Each of the nearby vehicles 1130 and 1140 may identify the first information of the nearby vehicle 1120 and acquire second information corresponding to the first information through a sensor. Each of the nearby vehicles 1130 and 1140 may acquire the second information by measuring a velocity of the nearby vehicle 1120. Each of the nearby vehicles 1130 and 1140 may transmit the acquired second information to the vehicle 1110.

The vehicle 1110 may compare the first information of the nearby vehicle 1120 to the second information of each of the nearby vehicles 1130 and 1140 to perform the reliability reverification on the nearby vehicle 1120. Specifically, the vehicle 1110 may determine whether a difference between the first information of the nearby vehicle 1120 and the second information of the nearby vehicle 1130 exceeds a predetermined threshold, and determine whether a difference between the first information of the nearby vehicle 1120 and the second information of the nearby vehicle 1140 exceeds the threshold. When at least one of the difference between the first information of the nearby vehicle 1120 and the second information of the nearby vehicle 1130 and the difference between the first information of the nearby vehicle 1120 and the second information of the nearby vehicle 1140 exceeds the threshold, the vehicle 1110 may determine that the nearby vehicle 1120 is unreliable. In other words, the vehicle 1110 may suspend the V2V communication with the nearby vehicle 1120 based on a reliability reverification result of the nearby vehicle 1120. When each of the difference between the first information of the nearby vehicle 1120 and the second information of the nearby vehicle 1130 and the difference between the first information of the nearby vehicle 1120 and the second information of the nearby vehicle 1140 does not exceed the threshold, the vehicle 1110 may determine that the nearby vehicle 1120 is reliable. In other words, the vehicle 1110 may maintain the V2V communication with the nearby vehicle 1120 based on a reliability reverification result of the nearby vehicle 1120.

Likewise, the vehicle 1110 may perform reliability reverification on the nearby vehicles 1130 and 1140, and determine whether to maintain or suspend the V2V communication with the nearby vehicles 1130 and 1140 based on reliability reverification results.

FIG. 12 is a flowchart illustrating operations of a vehicle, an external vehicle, and a server.

In operation S1201, a vehicle 1200 may transmit information on a position and a predicted driving route of the vehicle 1200 to a server 1210. For example, when setting a predicted driving route, the vehicle 1200 may transmit information on a position and the predicted driving route to a cloud server. In addition, the vehicle 1200 may periodically transmit information on a position and a predicted driving route to the server 1210 during driving. Also, in a case in which the vehicle 1200 is an autonomous vehicle, the vehicle 1200 may transmit information on a position and a predicted driving route to the server 1210 when performing autonomous driving.

In operation S1203, the server 1210 may transmit a vehicle list of vehicles to be included in a same group as the vehicle 1200 to the vehicle 1200. Specifically, the server 1210 may determine the vehicle list of vehicles to be included in the same group as the vehicle 1200 based on the position and the predicted driving route of the vehicle 1200. For example, the server 1210 may determine a vehicle list including vehicles which may travel within a predetermined distance from the vehicle 1200 for at least a predetermined period of time. Also, the server 1210 may manage reliability information of vehicles near the vehicle 1200 and determine a vehicle list including vehicles having relatively high reliabilities among the nearby vehicles based on the reliability information.

In operation S1205, an external vehicle 1220 may request the vehicle 1200 to perform the V2V communication.

In operation S1207, the vehicle 1200 may identify whether to allow the V2V communication with the external vehicle 1220 by determining whether the external vehicle 1220 is included in the vehicle list transmitted from the server 1210. Specifically, when the external vehicle 1220 is included in the vehicle list, the vehicle 1200 may allow the V2V communication with the external vehicle 1220. Also, when the external vehicle 1220 is included in the vehicle list, the vehicle 1200 may request information for reliability verification from the external vehicle 1220 and receive the first information for reliability verification from the external vehicle 1220. The vehicle 1200 may acquire second information corresponding to the first information from at least one nearby vehicle which is reliable, compare the first information and the second information, and identify whether to allow the V2V communication with the external vehicle 1220.

In operation S1209, the vehicle 1200 may transmit information on the external vehicle 1220 to the server 1210 based on a verification result of operation S1207. Specifically, when the vehicle 1200 allows the V2V communication with the external vehicle 1220, the vehicle 1200 may transmit information indicating that the external vehicle 1220 is reliable, to the server 1210. When the vehicle 1200 disallows the V2V communication with the external vehicle 1220, the vehicle 1200 may transmit information indicating that the external vehicle 1220 is unreliable, to the server 1210. The server 1210 may update information on a reliability of the external vehicle 1220 in a database. Also, the server 1210 may update information on the vehicles included in the same group as the vehicle 1200 in the database. In other words, the server 1210 may update the database such that the external vehicle 1220 is included in the same group as the vehicle 1200.

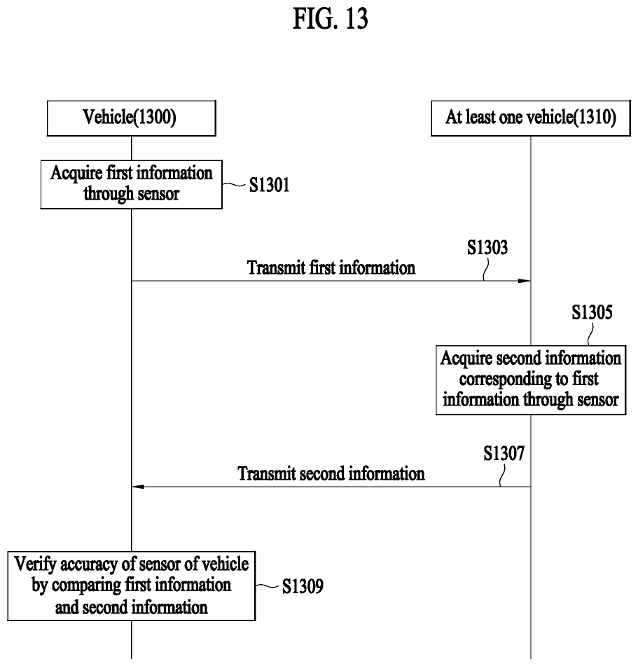

FIG. 13 is a flowchart illustrating operations of a vehicle and at least one vehicle.

In operation S1301, a vehicle 1300 may acquire first information through a sensor of the vehicle 1300. The vehicle 1300 may select a sensor to be used for verifying accuracy in the vehicle 1300 and acquire the first information through the selected sensor. For example, the vehicle 1300 may acquire first information indicating a position of the vehicle 1300 using a GPS sensor.

In operation S1303, the vehicle 1300 may transmit the acquired first information to at least one vehicle 1310. The vehicle 1300 may transmit a V2V message including the first information to the at least one vehicle 1310 which is reliable and in a vicinity of the vehicle 1300. When the at least one vehicle 1310 includes a first vehicle and a second vehicle, the vehicle 1300 may transmit the V2V message including the first information to each of the first vehicle and the second vehicle.

In operation S1305, the at least one vehicle 1310 may acquire second information corresponding to the first information through a sensor. Specifically, the at least one vehicle 1310 may identify the first information transmitted from the vehicle 1300 and acquire the second information corresponding to the first information through the sensor. For example, when the first information is velocity information of the vehicle 1300, the at least one vehicle 1310 may measure a velocity of the vehicle 1300 using the sensor and acquires information on the measured velocity as the second information.

In operation S1307, the at least one vehicle 1310 may transmit the second information acquired in operation S1305 to the vehicle 1300. The at least one vehicle 1310 may transmit the V2V message including the second information to the vehicle 1300.

In operation S1309, the vehicle 1300 may verify accuracy of a sensor of the vehicle 1300 by comparing the first information and the second information. The vehicle 1300 may determine a difference between the first information and the second information and verify the accuracy of the sensor based on the determined difference. When the difference between the first information and the second information is greater than a predetermined threshold, the vehicle 1300 may determine that the accuracy of the sensor is relatively low and thus, recognize that the sensor is malfunctioning.

The vehicle 1300 may perform calibration on the sensor based on the difference between the first information and the second information. Specifically, the vehicle 1300 may determine an error of the first information based on the second information determined as having a relatively high accuracy, and perform the calibration on the sensor based on the determined error.

As such, the vehicle 1300 may determine whether the sensor malfunctions or may perform the calibration on the sensor by verifying the accuracy of the first information acquired through the sensor of the vehicle 1300 based on the second information of the at least one reliable vehicle. Through this, the vehicle 1300 and nearby vehicles may share more accurate sensor information through the V2V communication.

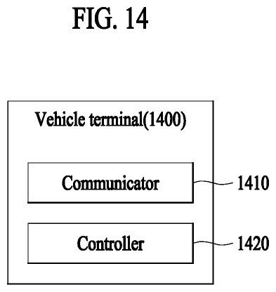

FIG. 14 is a block diagram illustrating a vehicle terminal.

The vehicle terminal 1400 may be a device disposed in a vehicle to assist driving of the vehicle. The vehicle terminal 1400 may include a communicator 1410 and a controller 1420. FIG. 14 illustrates only components of the vehicle terminal 1400 related to the present embodiment. Therefore, it will be understood by those skilled in the art that other general-purpose components may be further included in addition to the components illustrated in FIG. 14.

The communicator 1410 may communicate with an external electronic device. The external electronic device may be, for example, a nearby vehicle, a server, or an infrastructure such as a road side unit (RSU). The communicator 1410 may communicate with an external vehicle or a server based on V2V communication or vehicle to network (V2N) communication.

The communicator 1410 may use communications technology such as Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, and Near Field Communication (NFC), for example.

The controller 1420 may control an overall operation of the vehicle terminal 1400 and process data and a signal. The controller 1420 may include at least one hardware unit. In addition, the controller 1420 may be operated by at least one software module generated by executing program codes stored in a memory.

The controller 1420 may receive first information for reliability verification from an external vehicle through the communicator 1410.

The controller 1420 may request information for reliability verification from the external vehicle through the communicator 1410 and receive the first information for reliability verification from the external vehicle. As an example, the controller 1420 may receive a V2V communication request from the external vehicle. In this example, the controller 1420 may request information for reliability verification from the external vehicle and receive the first information for reliability verification from the external vehicle. As another example, the controller 1420 may perform V2V communication with the external vehicle. In this example, when a reliability verification period of the external vehicle elapses, the controller 1420 may request information for reliability verification from the external vehicle and receive the first information for reliability verification from the external vehicle.

The controller 1420 may receive a V2V message from the external vehicle and identify the first information for reliability verification in the V2V message.

The controller 1420 may transmit the first information to at least one vehicle in a vicinity of the vehicle through the communicator 1410. The controller 1420 may receive information associated with vehicles having a same group ID as the vehicle from a server through the communicator 1410 and transmit the first information to at least one vehicle having the same group ID as the vehicle.

The controller 1420 may receive second information acquired through a sensor of the at least one vehicle and corresponding to the first information, from the at least one vehicle through the communicator 1410.

The controller 1420 may identify whether to allow V2V communication with the external vehicle by comparing the first information and the second information. The controller 1420 may determine a difference between the first information of the external vehicle and the second information of the at least one vehicle, and determine whether to allow the V2V communication with the external vehicle based on the determined difference. When the determined difference is greater than a predetermined threshold, the controller 1420 may disallow the V2V communication with the external vehicle. When the determined difference is less than the threshold, the controller 1420 may allow the V2V communication with the external vehicle.

The controller 1420 may transmitting information associated with a position and a predicted driving route of the vehicle to the server through the communicator 1410. The controller 1420 may receive a vehicle list of vehicles to be in a same group as the vehicle from the server and determine whether to allow the V2V communication with the external vehicle by determining whether the external vehicle is included in the vehicle list.

The controller 1420 may transmit information acquired through a sensor of the vehicle to at least one vehicle in a vicinity of the vehicle. The controller 1420 may receive the second information acquired through the sensor of the at least one vehicle and corresponding to the first information, from the at least one vehicle. The controller 1420 may verify accuracy of the sensor of the vehicle by comparing the first information and the second information. Also, the controller 1420 may determine an error of the first information based on the second information and perform calibration on the sensor based on the determined error.

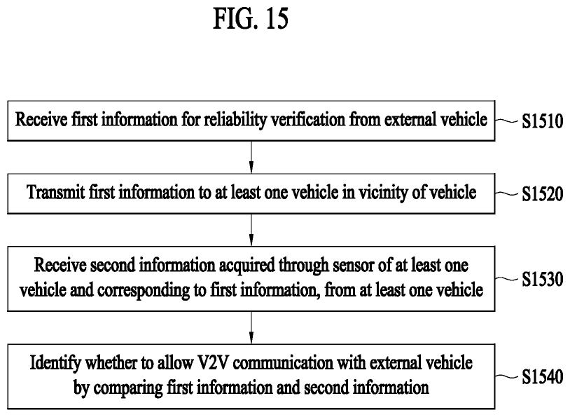

FIG. 15 is a flowchart illustrating an operation method of a vehicle terminal.

In operation S1510, a vehicle terminal 1400 may receive first information for reliability verification from an external vehicle.

In operation S1520, the vehicle terminal 1400 may transmit the first information to at least one vehicle in a vicinity of a vehicle.

In operation S1530, the vehicle terminal 1400 may receive second information acquired through a sensor of the at least one vehicle and corresponding to the first information, from the at least one vehicle.

In operation S1540, the vehicle terminal 1400 may identify whether to allow V2V communication with the external vehicle by comparing the first information and the second information.

The devices in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer readable recording medium as computer readable codes or program commands which may be executed by the processor. Here, the computer readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer readable recording medium may be dispersed to computer systems connected by a network so that computer readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

What is claimed is:

1. An operation method of a vehicle terminal, the method comprising:
receiving first information for reliability verification from an external vehicle;
transmitting the first information to at least one vehicle in a vicinity of a vehicle;
receiving second information acquired through a sensor of the at least one vehicle and corresponding to the first information, from the at least one vehicle; and
identifying whether to allow vehicle to vehicle (V2V) communication with the external vehicle by comparing the first information and the second information.

2. The operation method of claim 1, wherein the identifying comprises:
determining a difference between the first information and the second information; and
identifying whether to allow the V2V communication with the external vehicle based on whether the determined difference exceeds a predetermined threshold.

3. The operation method of claim 2, wherein the identifying comprises:
allowing the V2V communication with the external vehicle when the determined difference exceeds the predetermined threshold; and
disallowing the V2V communication with the external vehicle when the determined difference does not exceed the predetermined threshold.

4. The operation method of claim 2, wherein the identifying comprises:
allowing the V2V communication with the external vehicle in one direction when the determined difference exceeds the predetermined threshold.

5. The operation method of claim 1, wherein the receiving of the first information comprises:
receiving a V2V communication request from the external vehicle;
requesting information for reliability verification from the external vehicle; and
receiving the first information from the external vehicle based on the requesting.

6. The operation method of claim 1, wherein the receiving of the first information comprises:
determining whether a reliability verification period of the external vehicle elapses;
requesting information for reliability reverification from the external vehicle when the reliability verification period of the external vehicle elapses; and
receiving the first information from the external vehicle based on the requesting.

7. The operation method of claim 1, wherein each of the at least one vehicle identifies the first information and acquires second information corresponding to the first information through a sensor.

8. The operation method of claim 1, further comprising:
receiving, from a server, information associated with vehicles having a same group identification (ID) as the vehicle,
wherein the transmitting comprises:
transmitting the first information to at least one vehicle having the same group ID as the vehicle based on the information associated with the vehicles.

9. The operation method of claim 1, wherein the first information includes at least one of position information and velocity information of a predetermined vehicle acquired by the external vehicle, and
the second information includes at least one of position information and velocity information of the predetermined vehicle measured through the sensor of the at least one vehicle.

10. The operation method of claim 1, further comprising:
transmitting information associated with a position and a predicted driving route of the vehicle to a server; and
receiving a vehicle list of vehicles to be in a same group as the vehicle from the server,
wherein the identifying comprises:
determining whether the external vehicle is included in the vehicle list and identifying whether to allow the V2V communication with the external vehicle.

11. The operation method of claim 1, further comprising:
transmitting information acquired through a sensor of the vehicle to the at least one vehicle;
receiving the second information acquired through the sensor of the at least one vehicle and corresponding to the first information, from the at least one vehicle; and
verifying accuracy of the sensor of the vehicle by comparing the first information and the second information.

12. The operation method of claim 11, further comprising:
determining an error of the first information based on the second information and performing calibration on the sensor based on the determined error.

13. The operation method of claim 1, further comprising:
receiving an accuracy verification result of the first information through the sensor of the at least one vehicle from the at least one vehicle; and
identifying whether to allow the V2V communication with the external vehicle based on the accuracy verification result.

14. The operation method of claim 1, wherein the transmitting comprises:
transmitting the first information to a first vehicle and a second vehicle in a vicinity of the vehicle,
the receiving comprises:
receiving 2-1^{st} information acquired through a sensor of the first vehicle and corresponding to the first information from the first vehicle and receiving 2-2^{nd} information acquired through a sensor of the second vehicle and corresponding to the first information from the second vehicle, and
the identifying comprises:
identifying whether to allow the V2V communication with the external vehicle based on a comparison between the first information and the 2-1^{st} information and a comparison between the first information and the 2-2^{nd} information.

15. The operation method of claim 14, wherein the identifying comprises:
disallowing the V2V communication with the external vehicle when at least one of a difference between the first information and the 2-1^{st} information and a difference between the first information and the 2-2^{nd} information exceeds a predetermined threshold; and
allowing the V2V communication with the external vehicle when both a difference between the first information and the 2-1^{st} information and a difference between the first information and the 2-2^{nd} information do not exceed the predetermined threshold.

16. A non-volatile computer readable recording medium comprising a computer program for executing the operation method of claim 1.

17. A vehicle terminal comprising:
a communicator; and
a controller configured to receive first information for reliability verification from an external vehicle through the communicator, transmit the first information to at least one vehicle in a vicinity of a vehicle, receive second information acquired through a sensor of the at least one vehicle and corresponding to the first information from the at least one vehicle, and identify whether to allow vehicle to vehicle (V2V) communication with the external vehicle by comparing the first information and the second information.

18. The vehicle terminal of claim 17, wherein the controller is configured to receive a V2V communication request from the external vehicle through the communicator, request information for reliability verification from the external vehicle, and receive the first information from the external vehicle based on the requesting.

19. The vehicle terminal of claim 17, wherein the controller is configured to determine whether a reliability verification period of the external vehicle elapses, request information for reliability reverification from the external vehicle through the communicator when the reliability verification period elapses, and receive the first information from the external vehicle based on the requesting.

20. The vehicle terminal of claim 17, wherein the controller is configured to transmit information acquired through a sensor of the vehicle to the at least one vehicle through the communicator, receive the second information corresponding to the first information and acquired through the sensor of the at least one vehicle from the at least one vehicle, and verify accuracy of the sensor of the vehicle by comparing the first information and the second information.
